(19) United States
(12) Patent Application Publication
(10) Pub. No.: US 2012/0085867 A1
(43) Pub. Date: Apr. 12, 2012

(54) HEATING SYSTEM

(76) Inventor: Anthony Edward Bardwell, Isle of Wight (GB)

(21) Appl. No.: 13/318,889

(22) PCT Filed: May 6, 2010
(86) PCT No.: PCT/GB2010/000909

§ 371 Date: Dec. 13, 2011

(30) Foreign Application Priority Data
May 6, 2009 (GB) 0907815.5

(51) Int. Cl. B64D 15/02

(52) U.S. Cl. 244/134 B

(57) ABSTRACT

A heating system for heating at least a portion of a leading edge (114) of an aircraft wing (112). The system comprising a first portion (5) of a heat pipe (4) positioned between an end of an aircraft wing support rib (6) and a portion of the leading edge (9) proximate to the end of the support rib wherein heat from the heat pipe is transferable to the proximate portion of the leading edge profile.

### FIELD

The present invention relates to anti-icing and de-icing systems for external surfaces of aircrafts and in particular, but not exclusively, to anti-icing and de-icing systems for leading edges of aircraft wings. It will be appreciated that the invention is not limited to this particular field of use.

### BACKGROUND

Aircraft flying in conditions where water droplets or vapour are present, and where the air temperature is below freezing (or where the airframe is extremely cold), often experience ice formation on the exterior surfaces of the aircraft body. This is particularly common on leading edge components of the aircraft such as the wings. Flying in these conditions for extended periods of time can cause significant ice formation on the aircraft surfaces.

It is known that the formation of ice on the surface of a wing can change the aerodynamic shape of the wing resulting in a disruption to the aerodynamic efficiency and a consequential reduction in the stability of the aircraft during flight. In particular, ice built up on the surface of the aircraft's wings prevents the correct laminar air flow necessary to generate sufficient lift and can influence the controllability of the aircraft.

Ice also adds to an aircraft's overall weight and can be hazardous to the aircraft's engines if large pieces of ice separate from the surfaces and are ingested into engines or impact moving propellers or blades. Thick ice can also cause control surfaces on the aircraft wings to lock up and prevent normal movement.

The seriousness of these problems in the aviation industry has led to a number of systems to prevent ice formation on aircraft. For example, aircraft may be treated with de-icing fluids before flight and may also be equipped with anti-icing or de-icing systems.

A known method for preventing ice from forming on a wing, and avoiding the associated problems mentioned above, is to affix a heating system to the wing. An example of such a heating system is described in GB 1110217 where a heater mat is bonded to the interior of a portion of a leading edge profile of a wing. The heat energy from the heater mat is then transferred through to the external surface of the leading edge thereby heating the outer surface to prevent ice build up.

Heating systems, such as the one described in GB 1110217, are applied on the inside of the leading edge of the wing prior to the installation of the wing support ribs. The heater can thereby be sandwiched between the leading edge profile of the wing and the support ribs within the wing to secure the heater in place and ensure effective contact with the surface to be heated. However, a disadvantage with this arrangement is that the support ribs must be disassembled from the leading edge profile in order to repair or replace the heater mat(s). This is solved by locating heater mats between the support ribs and permitting the ribs to be coupled directly to the leading edge. This advantageously maintains structural strength and allows access to the heater mats. However, this arrangement results in non-uniformity of heating at the leading edge owing to the spaces between heating mats corresponding to the rib locations. This problem can be addressed by locating heater mats over the support ribs as shown for example in FIG. 5 of the present application. In order to provide a uniform heat output to the wing these overlapped portions require higher capacity heaters to ensure sufficient heat is conducted to the leading edge.

The present invention has been made, at least in part, in consideration of these and other problems and drawbacks with the prior art.

### SUMMARY

Viewed from a first aspect, there is provided a heating system for a leading edge of an aircraft wing, said system comprising a heat pipe having a first end arranged in use to receive input heat and a second end arranged in use to dissipate heat, wherein said second end of said heat pipe is positioned between an end portion of a wing support rib and an adjacent portion of a leading edge.

Thus, there is provided a heating system for heating a portion of a leading edge of an aircraft wing comprising a first portion of a heat pipe positioned between an end of an aircraft wing support rib and a portion of the leading edge proximate to the end of the support rib, wherein heat from the heat pipe is transferable through the proximate portion of the leading edge.

A heat pipe is a device which transfers heat from one hot portion of the ‘pipe’ to a cold portion of the ‘pipe’ by means of an evaporation and condensing cycle within the heat pipe device. Although described as a heat ‘pipe’, the shape and configuration of the device can be adapted according to the specific application. Heat pipes are conventionally used to cool components in various applications, such as in the semiconductor industry, where electronic components are liable to overheat.

A conventional heat pipe allows heat to be transferred from a hot portion of the pipe (where evaporation occurs within the pipe) to a colder portion (where condensing occurs within the pipe). Thus heat pipes are suitable for cooling applications such as in the electronics industry. One portion of the heat pipe is disposed at or near the region of the component where cooling is desired and the other portion at a position where heat can be dissipated to atmosphere.

A heat pipe is formed of a sealed thermally conductive chamber containing a coolant in the form of a fluid. The fluid is free to flow within the chamber of the device between the hot and cold portions (in some applications by means of a wick within the device). In use, fluid at the hot end (or interface) of a heat pipe evaporates to vapour as this portion of the pipe is heated. Movement of the fluid within the sealed chamber causes fluid to move to the colder portion within the pipe where the fluid condenses releasing heat. The fluid then returns back to the hot portion to form a thermodynamic cycle.

As stated above, heat pipes are conventionally used to provide cooling to heat-sensitive components, such as semiconductor components or the like. Such heat pipes are commercially available and are not therefore described in detail. However, the inventors have discovered that a heat pipe may be adapted and advantageously employed in the field of the present invention.

Specifically, by locating a heat pipe between an end of a support rib and a corresponding portion of the leading edge of an aircraft wing, heat can be directed to the leading edge of the wing by applying heat to the opposing end of the heat pipe. In effect the conventional application and operation of the heat pipe is reversed.

Thus, the heating means can be located remotely from the position at which heat is required to de-ice the leading edge and the heat pipe can be employed as an effective means to transfer the heat from the heaters to the leading edge. This advantageously allows for access and maintenance of the heaters and further removes the need to disassemble the connection between leading edge and rib for maintenance.

The profile and arrangement of the heat pipe can be conveniently adapted to match the specific contours of the interface between the inner surface of the wing (or component to be heated) and the corresponding support e.g. a support rib. In addition, the heat pipe may advantageously be arranged as a load bearing component (or a part of the heat pipe may be arranged as a load bearing component) so as to accommodate loads between the support rib and leading edge. This can be achieved by adapting the cross-section of the heat pipe to provide heat channels around load bearing portions.

Heat may be applied to the first end of the heat pipe using any convenient means. For example, an electrical heater may conveniently be arranged against or around one end of the heat pipe and activated to heat one end of the pipe. Thus, the device can be conveniently powered electrically from the aircraft's electrical generators or batteries. In use the applied heat is communicated to and dissipated at the second end of the heat pipe and conducted to the leading edge of the wing.

The second end of the pipe (the heat dissipation end) may advantageously be coupled to (or positioned adjacent to) the inner surface of the leading edge of the wing between the wing surface and the associated support rib. The pipe may advantageously cover the entire portion of the support rib connected to the leading edge so as to maximise heat transfer to the leading edge.

The respective ends of the heat pipe may comprise different geometries—a first end adapted to correspond to the shape of the support rib and a second end adapted to receive a heating means. Adapting the heat pipe in this way may advantageously prevent any unheated portions of the leading edge forming and can also reduce the electrical load required to heat the leading edge portion of the wing.

According to an invention described herein, conventional heating mats can be located between adjacent support ribs to heat the portions of the leading edge extending between each rib. Heat pipes may then be located at each of the support ribs as described above. This thereby provides a wing heating system which is arranged to provide a uniform heat supply to the length of the leading edge of the wing and thereby prevents isolated regions of ice building up. It will be recognised that the invention extends to a wing heating system incorporating a combination of heat mats and heat pipes suitably arranged along a wing.

The arrangement according to the present invention permits more convenient maintenance of the heater mats because there is no need to disassemble the support rib from the leading edge in order to access the mat or electrical connections. This arrangement also provides corresponding advantages in the design and construction of the support rib and leading edge coupling. The heat pipes themselves advantageously have long service intervals, owing in part to the lack of moving parts, and this further improves the reliability and service interval length of the heating system according to the present invention.

Heat pipes also advantageously dissipate heat to the coldest portions of the ‘cold’ end of the pipe. According to the present application, this advantageously provides heat to the coldest part of the leading edge of the wing which may correspond to the portion where ice has already developed or where ice is likely to form.

The heating means providing heat to the heat pipe may be any suitable arrangement. For example, the heating means may include engine exhaust or hot gas channelled from the engines into the wing cavity. In such an arrangement the first end of the heat pipe may be provided with a heat sink to collect heat from the hot gas. This advantageously makes use of the otherwise wasted hot exhaust gas.

Alternatively, the heating means may comprise other heating devices, such as electrically powered resistive heater mats. This advantageously provides for accurate and selective control of the heater mats. For example, the electrical heaters may be operated in a cycle to reduce the peak load of electrical power needed to heat the wing. This may for example be controlled by means of a suitable automatic control unit or manually by the pilot or flight engineer.

The heating system may also be provided with temperature sensors disposed proximate the wing surface and coupled to the control unit. Thus, electrical power can be provided to the coldest heat pipes first to control the ice layer in response to information received from local temperature sensors.

The heat pipe may be arranged between the support rib and the adjacent leading edge inner surface in a variety of ways depending on the application.

For example, one end of the heat pipe (or portion depending on the shape of the heat pipe) may be located between the inner surface of the wing and the opposing surface of the support rib and secured by releasable fixing means such as bolts, screws or other suitable fastening to allow for maintenance if and when required. The support ring may be provided with suitable holes through which the fixing means may pass.

Alternatively, the heat pipe may be bonded to the two components using a suitable adhesive or the like so as to provide a fixed coupling between the components of the heating system.

In order to locate the heat pipe proximate to the leading edge, the support rib may be provided with a recess or orifice (e.g. a machined slot) arranged to receive the heat pipe (or a portion thereof) or the rib itself may be provided with a cavity into which the working fluid can be contained. Such an arrangement provides a combined or integrated support rib and heat pipe arrangement.

Thus, viewed from another aspect there is provided a support rib for an aircraft wing comprising a central beam portion and a circumferentially extending portion arranged to be coupled to an inner surface of a wing leading edge, said rib comprising at least one integral heat pipe arrangement having a first end arranged in use to receive input heat and a second end arranged in use to dissipate heat.

In such an arrangement the circumferentially extending portion can advantageously align with the profile of the leading edge. The central beam portion provides the structural strength of the component. The first end of the heat pipe may be arranged within the central beam portion and the second end arranged in the circumferentially extending portion. The arrangement may comprise a plurality of radially extending heat pipes arranged in use to transfer heat from the first ends to the second ends proximate to the leading edge of the wing.

In such an integrated arrangement the support rib may be provided with a suitable portion or area which is adapted to receive heat from a heating means required to heat the heat pipe (as described above). In such an arrangement the support rib and heat pipe may be conveniently installed as a single component.

Integrating a portion of the heat pipe or the entire heat pipe within the rib may provide greater structural support to the wing assembly when compared with an arrangement where the heat pipe is located between the rib and the wing and coupled thereto. An integrally formed support rib and heat pipe in effect advantageously reduces the number of layers which are coupled together in the wing.

A series of heat pipes may advantageously be arranged around the circumference of the support rib. The series of heat pipes can thus align with the region of the leading edge where ice may form and these portions of the wing can be heated.

The portions of the heat pipes which are arranged to receive the heat supply (for example by means of electrical heating mats) may be arranged to extend from one side of the support rib to facilitate electrical connection or installation. Alternatively the pipes may alternate on either side of the rib if space in the wing cavity requires such an arrangement.

Alternatively a pair of opposing heat pipes may be arranged on either side of the support rib. This may advantageously provide additional heating and/or redundancy in the heating system to accommodate any failure or malfunction.

In a still further arrangement, a modified heat pipe may be provided with a single heat dissipation portion arranged between the leading edge and the support rib and two portions extending on either side of the rib, each arranged to receive heating means.

The heat pipe may be formed from a variety of shapes as required by the wing and support rib geometry and the particular aircraft heating requirements. For example, the heat dissipation portion of the heat pipe(s) may be provided with a curvature matching the inner surface of the wing in order to maximise contact and heat transfer. In such an arrangement the heat pipes may be curved along their length with a curvature corresponding at least in part to the curvature of the leading edge. Such an arrangement may advantageously allow larger heat pipes to be installed maximising the contact between the heat pipe and the inner wing surface. Alternatively a plurality of discrete heat pipes may be provided along and around the inner surface of the wing which may provide greater heating control.

The internal cross-section of the heat pipe may be round, oval, square or rectangular, depending on the heating needs for the area of the leading edge to be heated. In embodiments where the heat pipe is a separate component i.e. not integrated with the rib, a heat pipe having a flat or planar shape may advantageously be selected to minimise the thickness of the arrangement.

In embodiments where a heat dissipation portion of the heat pipe is disposed within a cavity or recess formed in the support rib, a heat pipe having a circular cross-section could be conveniently utilised in order to facilitate manufacture of the rib and heating system. In other applications heat pipes having a rectangular cross-section may be advantageous over circular cross-section pipes where a heat pipe is required to have a greater surface area in contact with the leading edge.

According to a further aspect of the invention, there is provided a method of heating a portion of a leading edge of an aircraft wing, the method comprising the steps of positioning at least a portion of a heat pipe between an end of an support rib and a portion of the leading edge proximate to the end of the support rib and heating the heat pipe such that heat is transferred from the heat pipe to the proximate portion of the leading edge.

According to a further aspect of the invention, there is provided a support rib for an aircraft wing comprising a heat pipe.

Still further, there is provided an aircraft heating system comprising a heat pipe and an electrically operated heating mat, the heat pipe being arranged in use to be coupled at a first end to an electrically operated heating mat and at a second end to a portion of an aircraft structure. Viewed from another aspect there is provided a method of heating an aircraft component by activating a heating system as described above.

According to a further aspect of the invention, there is provided a wing including at least one support rib as described herein. According to a further aspect of the invention, there is provided an aerodynamic component comprising a heat pipe arranged in use to transfer heat from a heat source to a portion of the exterior of the aerodynamic component.

### BRIEF DESCRIPTION OF THE DRAWINGS

Specific embodiments will now be described, by way of example only, with reference to the accompanying drawings in which:

FIG. 1 is a perspective view of an aircraft wing and an example of a leading edge component, namely a wing slat;

FIG. 2 is a cross-sectional side view of the wing shown in FIG. 1;

FIG. 3 is a cross-sectional side view of an example of a rib mounting arrangement for a leading edge component;

FIG. 4 is a schematic view of an example of a heat pipe;

FIG. 5 is a cross-section view of heater mats coupled to a support rib and leading edge;

FIGS. 6A and 6B illustrate the basic arrangement of a wing support rib and leading edge;

FIG. 6C is a cross-sectional side view of a leading edge profile of an aircraft wing including a heating system in accordance with the invention;

FIGS. 7A is cross-section view corresponding to E-E′ in FIG. 7B of the support rib viewed from the rear of the wing towards the leading edge;

FIG. 8 is a cross-section view of the heating system at the interface between the support rib and leading edge;

FIG. 9 is a cross-section view of an alternative heating system at the interface between the support rib and leading edge;

FIG. 10 is a side view of a support rib illustrating alternative embodiments of heating means in accordance with the invention;

FIG. 11 is a cross-sectional view of the heating system of FIG. 10 taken on line 11-11, wherein the heat pipe is wholly encased within the support rib;

FIG. 12 is a cross-sectional view of the interface between the support rib and leading edge in accordance with a further embodiment of the present invention;

FIG. 13 is a view of a portion of a support rib corresponding to region X shown in FIG. 6A;

FIG. 14 is a cross-sectional view taken on line 14-14 of FIG. 13;

FIGS. 15 and 16 are cross-sectional views of an alternative heat pipe arrangement corresponding to the cross-section shown in FIG. 14.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### SPECIFIC DESCRIPTION

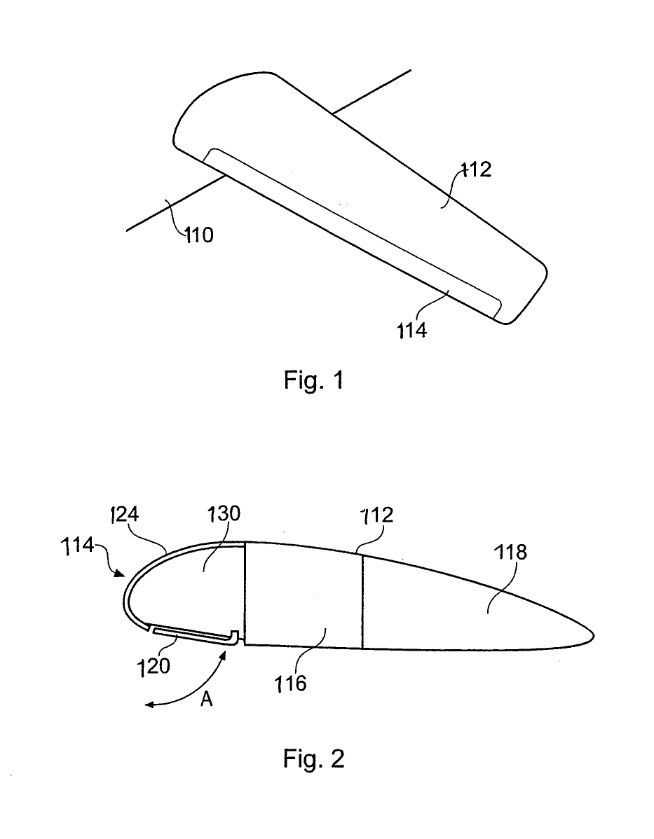

Leading edge components, such as a wing slat, typically include an outer skin (alternatively referred to as an erosion shield) which is aerodynamically shaped. An example is shown in FIGS. 1 and 2.

FIG. 1 shows a wing 112 of an aircraft 110 comprising such a wing slat 114. FIG. 2 shows a cut away view of the wing 112 shown in FIG. 1. In this example, the wing 112 includes a box portion 116 which is substantially rigid and which provides structural strength for the wing 112. The box portion 116 may for example house one or more fuel tanks and is defined on either side by a support rib.

In this example, toward the front of the wing 112 a leading edge component, namely a wing slat 114, is provided. The wing slat 114 includes an outer skin 124 and is supported by a plurality of support ribs 130. The support ribs extend from the front to the rear of the wing and provide structural strength to the wing assembly. A plurality of such ribs can be arranged along a length of the wing slat 114 for providing structural strength. The wing 112 can also include further moveable elements such as a Kruger flap 120, which in this example can pivot (as shown generally by the arrow labelled A in FIG. 2) out from the wing for modifying the aerodynamic characteristics of the wing 112. Such components can become jammed if ice is permitted to build up on the wing.

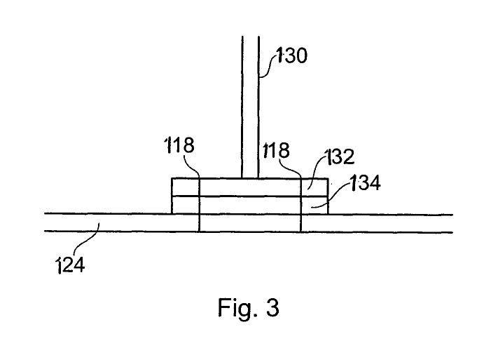

As is shown in FIG. 3, the supporting ribs 130 of the wing slat 114 can be attached at right angles to the outer skin 124 for providing structural support. In FIG. 3, the attachment of the rib 130 can be achieved by providing the rib with a flange 132 which extends generally perpendicular to the elongate portion of the support rib. The flange is attached to the outer skin 124 by means of an adhesive 134 located in-between the flange 132 and the outer skin 124. Alternatively, or additionally, a plurality of rivets 18 may pass through the flange and the outer skin 124 to couple the arrangement together. In an alternative arrangement the support may be in the form of an L-shaped rib comprising a flanged portion only extending to one side of the rib, unlike the T-shaped ribs shown in FIG. 3.

The heating system according to the present invention provides one or more heat pipes (reference 4 in the accompanying drawings) with at least a first portion 5 positioned between an end of one of the aircraft wing support ribs 6 and a corresponding portion of an internal surface 7 of a leading edge. According to the invention heat energy from the heat pipe 4 can thereby be conveniently transferred to the inner surface of the leading edge and through to the exterior surface 9 of the leading edge.

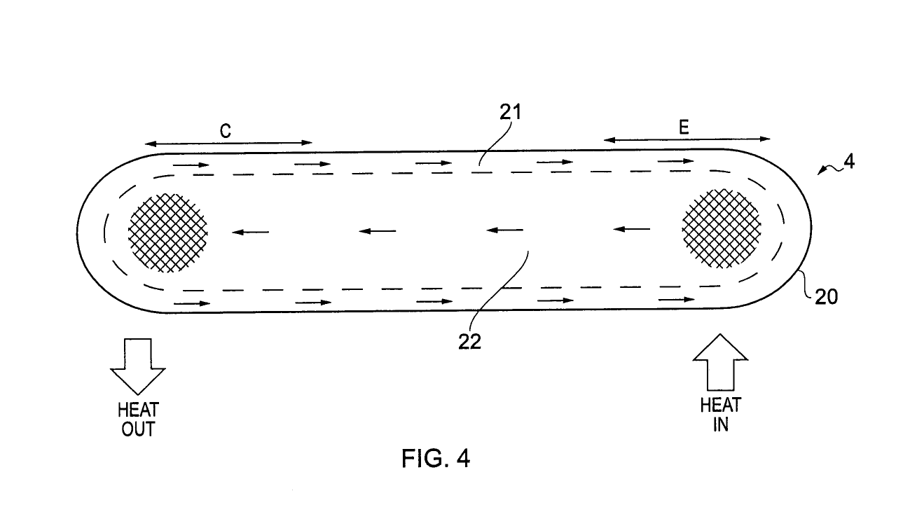

Heat pipes are known in other fields of technology and in particular the semiconductor industry. A schematic of a heat pipe suitable for use according to the present invention is shown in FIG. 4.

The heat pipe 4 consists of a vacuum tight casing 20, a wick 21 containing working fluid and a hollow cavity 22. The heat pipe comprises a first end denoted by the reference letter E where evaporation of the working fluid occurs when heat is applied to this end of the pipe. The heat pipe comprises a second end, denoted by the reference letter C, where condensing occurs.

In use, when the end portion (E) of the heat pipe 4 is heated the working fluid evaporates to vapour, absorbing thermal energy. The vapour migrates along the cavity 22 to the lower temperature end/region (C) of the pipe. The vapour then condenses in region C releasing heat and the fluid returns to the heated end along the wick 21.

A cycle is created in the pipe in which the condensing end of the heat pipe acts as a heat sink for the heat which is being applied to the evaporation end of the pipe. This thermodynamic cycle can conveniently be used in a reverse mode of operation to that which it is conventionally utilised for i.e. to transfer heat to a component as opposed to away from a component.

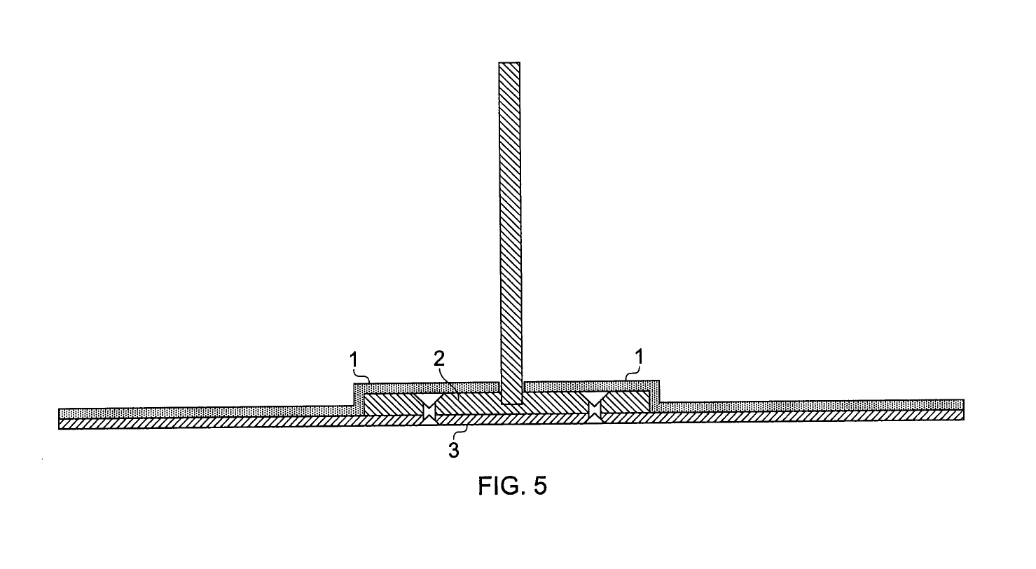

FIG. 5 shows an arrangement of heater mats extending on either side of a support rib and further heater mats overlapping the portion of the support rib which is attached to the leading edge by rivets 2. This represents a conventional wing heating systems as can be found in the art.

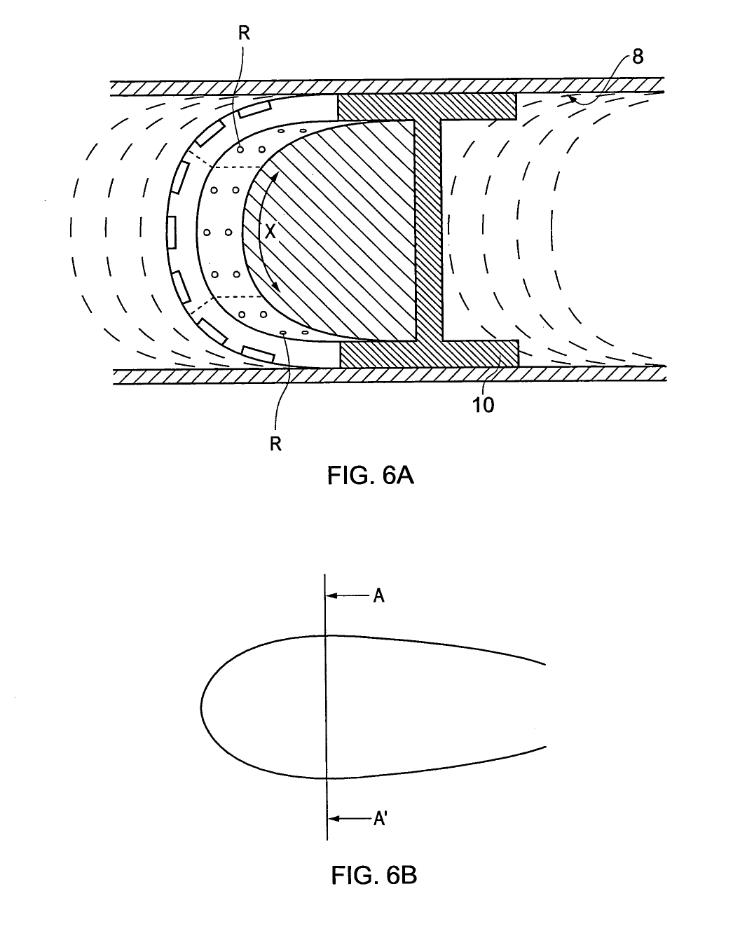

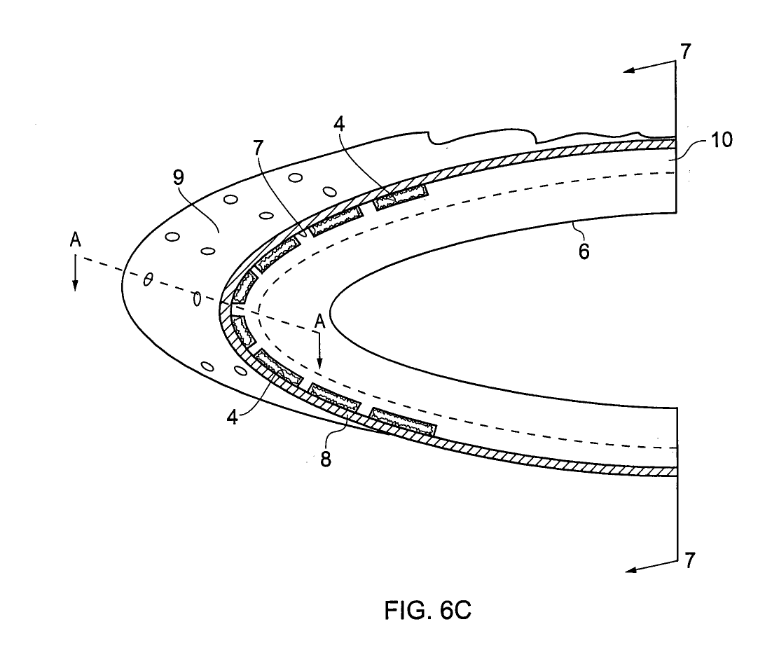

FIG. 6A illustrates the basic geometry of an aircraft support rib within the wing i.e. viewed from the trailing edge of the wing towards the front of the wing. FIG. 6B shows the wing in cross-section illustrating the view of FIG. 6A which is a cross-section through A-A′.

As shown in FIG. 6A, the support rib 6 is generally in the form of an ‘I’ having an outer profile corresponding substantially to the inner surface of the aircraft leading edge 8. It will be recognised that the selected profile of the support rib is dependent on the particular aircraft and the position of the support rib along the length of the aircraft wing.

The support rib may be connected to the leading edge by means of rivets R extending around the flange portion of the beam.

FIG. 6C is a view of a wing support rib and heating system as viewed from the front of the leading edge and into the wing (i.e. from the front of the wing viewed towards the rear). In the embodiment shown, the heating system comprises a plurality of heat pipes 4 extending around the flange of the support rib. In the embodiment shown in FIG. 6C the heat pipes are each formed integrally within the support rib 6. The shaded areas in FIG. 6C indicate the locations of heat pipes around the periphery of the support rib.

The individual heat pipes 4 in this embodiment are generally rectangular in cross-section (i.e. the internal cavity of the heat pipes are rectangular). The individual heat pipes are arranged at discrete positions around the circumference of the leading edge profile 8. Some of the heat pipes are located above the leading edge centre line A-A and some of the heat pipes are located below the centre line. This provides heating around the entire leading edge of the wing.

The extent to which the heat pipes 4 are arranged around the circumference of the leading edge i.e. how far along the wing the pipes extend from front to back of the aircraft, may vary depending on the geometry of the wing and the areas where ice may accumulate. Factors, such as the airflow over a wing during flight resulting in more ice accretion at the leading edge centre line and less ice accretion towards the trailing edge, may be considered when establishing the range of heating to be provided above and below the centreline A-A.

For example, the heat pipes 4 may extend around the circumference of the leading edge to approximately 0.25 m to 0.27 m above the leading edge centre line A-A and approximately 0.18 m to 0.20 m below the leading edge centre line A-A.

In a further embodiment, instead of a plurality of discrete heat pipes a single heat pipe 4 could be arranged to extend around the circumference of the entire upper and lower areas of the leading edge to be heated.

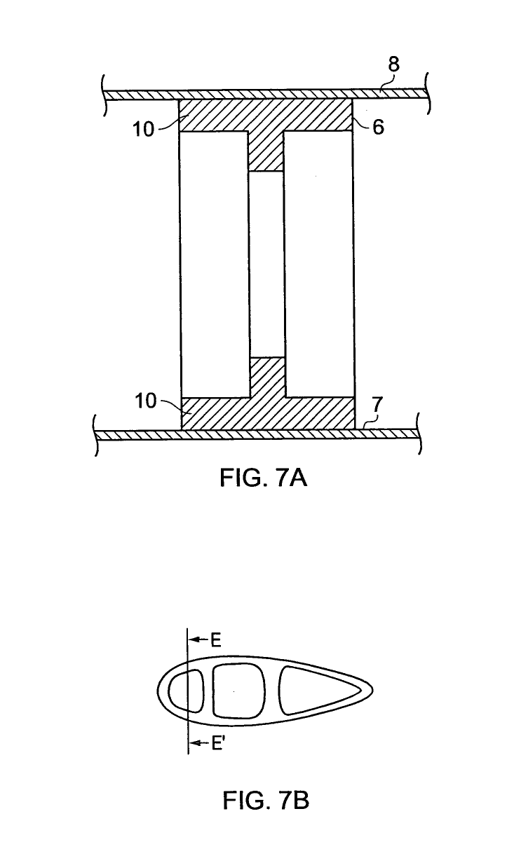

FIG. 7A shows a cross-section through E-E shown in FIG. 7B. FIG. 7B itself illustrates a support rib. The support rib 6 may have a central portion(s) removed (to reduce the overall weight of the rib) such that the cross-section is formed of a T-shape extending around the periphery of the rib. The base or flange portion 10 (formed of the T section) is affixed to the internal surface 7 of the leading edge 8 to connect the rib to the leading edge. The base of flange portion 10 may be affixed to the leading edge 8 by any suitable means, such as rivets, screws or by an adhesive depending on the aircraft and materials used for the ribs and wing surfaces.

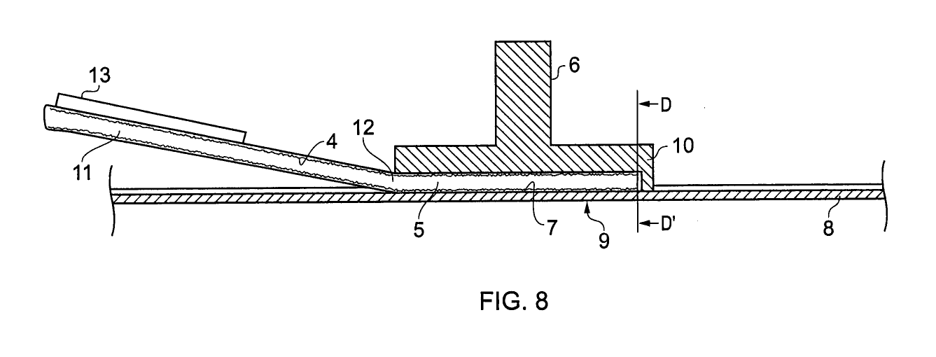

FIG. 8 shows a cross-sectional view of the heat pipe 4 with a first portion 5 located within a cavity formed within the base portion 10 of the support rib 6. This cavity may be formed as a slot machined into the distal portion of the support rib which abuts the leading edge. According to such an arrangement the heat pipe can be conveniently inserted into the slot and removed for maintenance if required. The first portion 5 of the heat pipe 4 is located between the end of the support rib 6 and the opposing internal surface 7 of the leading edge 8. The first portion 5 of the heat pipe corresponds to the condensing portion C of the heat pipe shown in FIG. 3.

The heat pipe 4 includes a second portion 11 which extends from the first portion 5. The second portion 11 of the heat pipe corresponds to the evaporation portion E of the heat pipe shown in FIG. 3.

Heating means, in the form of an electrically powered heater mat 13, is affixed to the second portion 11 of the heat pipe 4 so as to transfer heat to the first portion 5. As discussed above, with reference to FIG. 3, heat is communicated by the heat pipe to the condensing end where heat is dissipated to the external wall of the heat pipe. The condensing end of the heat pipe is arranged, as shown, adjacent to the leading edge which acts as a heat sink for the heat pipe when the heat pipe is activated. Heat is thereby transferred by conduction from the outer surface of the heat pipe to the leading edge of the wing thereby heating the portion of the wing surface adjacent to the support rib.

As shown in FIG. 8, the electrical heaters 13 may be conveniently attached to the evaporation end of the heat pipe and disposed within the wing cavity between adjacent support ribs. This allows for easy access to the heaters and heat pipes for electrically connecting the heater mats. The evaporation portion of the heat pipe may advantageously be elevated relative to the elongate axis of the condensing portion of the heat pipe. Such a configuration can improve the performance and operation of the pipe.

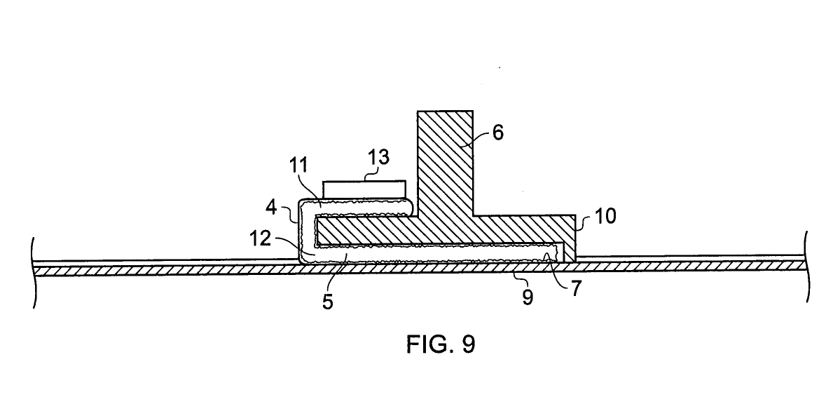

The geometry of the heat pipes 4 may alternatively be adapted depending on the space available within the wing cavity and between support rib arrangements. For example the heat pipe may be arranged into any configuration suitable for the available space within the wing cavity. An alternative arrangement is shown in FIG. 9 where the condensing portion of the heat pipe is disposed in a cavity or slot between the rib and the leading edge and the evaporation end of the pipe is arranged to follow the contour of the rib. Such an arrangement may reduce overall space consumption within the wing but may reduce overall efficiency owing to heat conduction between the ends of the heat pipe through the flange portion of the support rib. Suitable insulation may in such an arrangement be provided to improve the heat pipe efficiency.

Heater mats suitable for use with the present invention may comprise, for example, a fabric carrier such as dry glass cloth and an electrically conductive medium. The electrically conductive medium can be adhered to the fabric carrier using a resin infusion process. Passing a current through the electrically conductive medium generates heat within the mat which is conducted to the heat pipe.

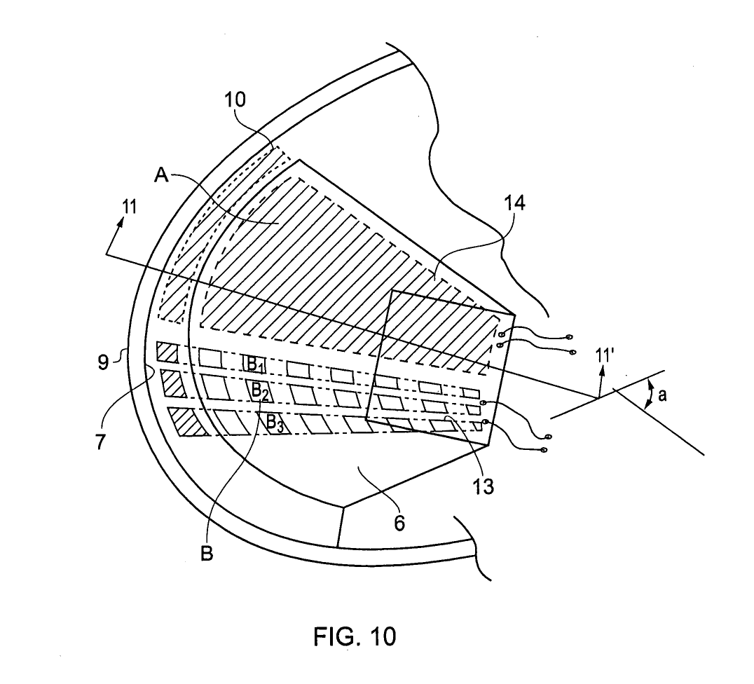

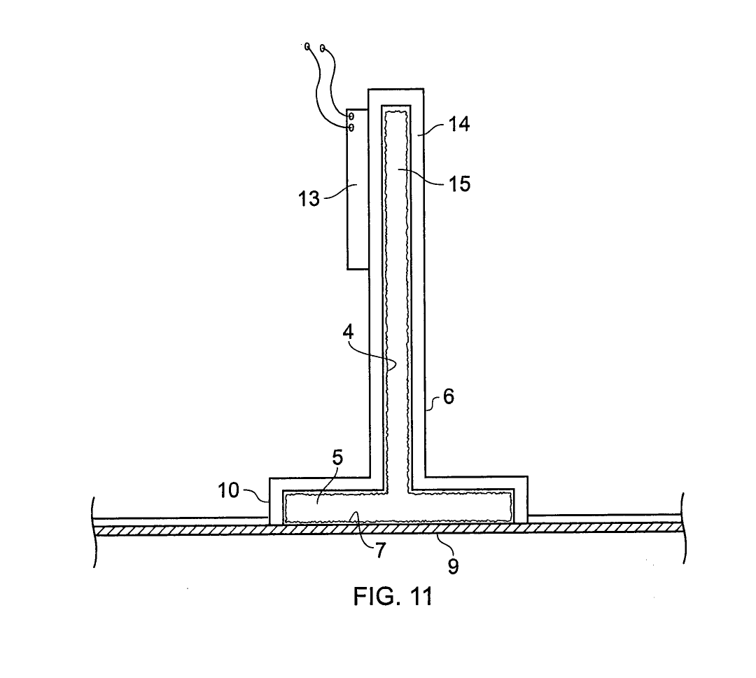

FIGS. 10 and 11 show two alternative heat pipe configurations wherein the heat pipe 4 is integrated into the support rib 6. In such arrangements the support rib and heat pipe are a single component.

FIG. 10 is a side view of one support rib viewed along the length of the wing. In the arrangement shown in FIG. 10 the support rib extends around only part of the circumference of the leading edge illustrated by angle ‘a’. FIG. 11 shows a cross-sectional view of the heat pipe 4 through view 11-11′ illustrated in FIG. 10.

FIG. 11 shows the T-shaped cross-section of the support rib. Heating means in the form of an electrically powered heater mat 13 is affixed to the stem portion 14 of the support rib 6. The heater mat 13 is positioned adjacent to a corresponding distal end 15 of the heat pipe 4. As shown in this particular arrangement, the heat pipe is arranged in a cavity formed within the T-section of the support rib. The evaporation portion of the heat pipe is arranged towards the top of the rib proximate the heating means 13 and the condensing portion in arranged towards the bottom of the rib proximate the leading edge surface 9.

In this arrangement, heat energy is transferred from the heater mat 13 through the distal end 14 of the support rib 6 to the distal end 15 of the heat pipe 4. Heat is then communicated by means of the heat pipe to the first portion 5 of the heat pipe 4 and through to the proximate external surface 9 of the leading edge 8.

FIG. 10 also illustrates two alternative heat pipe arrangements identified by region A and region B in FIG. 10.

Region A illustrates an arrangement where the heat pipe is formed within the support rib as a single cavity denoted by the hatched area. Region B illustrates an alternative arrangement where a plurality of individual heat pipes are arranged within the rib extending radially from the heater 13 as separate channels. In this arrangement a single heater is shown and arranged to heat a plurality of evaporating portions of heat pipes B1, B2, B3. In another arrangement individual heaters may be arranged to heat each heat pipe (not shown).

It will be recognised that whilst a T-section of heat pipe is shown, the heat pipe may be arranged to extend only into one side of the ‘T’ proximate the leading edge i.e. in an ‘L’ shape. In such an arrangement consecutive heat pipes (shown as B1, B2 and B3) arranged around the leading edge may be arrange to alternate between each side of the L section to provide uniform heating on each side of the rib.

The heat pipe arrangement of FIGS. 10 and 11 may advantageously provide heat to the centre line A-A of the wing leading edge shown in FIG. 6C where ice may begin to build up.

The heating requirements of the leading edge are greater at the front of the wing than the portions of the wing toward the trailing edge i.e. towards the rear of the wing. In order to accommodate this kind of tapered heat distribution in a system such as that shown in FIG. 6A or region B of FIG. 10, each heat pipe may be independently controlled to control the temperature at these particular regions of the wing. Alternatively the heat pipes may be different sizes with associated different thermal output characteristics to provide the desired heat output at each location along and around the wing.

In the embodiment shown in region A of FIG. 10 and also in FIG. 11, the heat pipe extends around the entire upper and lower portion of the leading edge of the wing. Consequently, the individual regions cannot be controlled. However, heat may still advantageously be uniformly distributed on account of the properties of heat pipes which inherently dissipate greater heat to colder regions where increased condensing occurs. Therefore in an arrangement such as the one shown in FIGS. 10 (region A) and FIG. 11, heat can be distributed to the coldest areas of the leading edge profile where ice may be present regardless of the heater input.

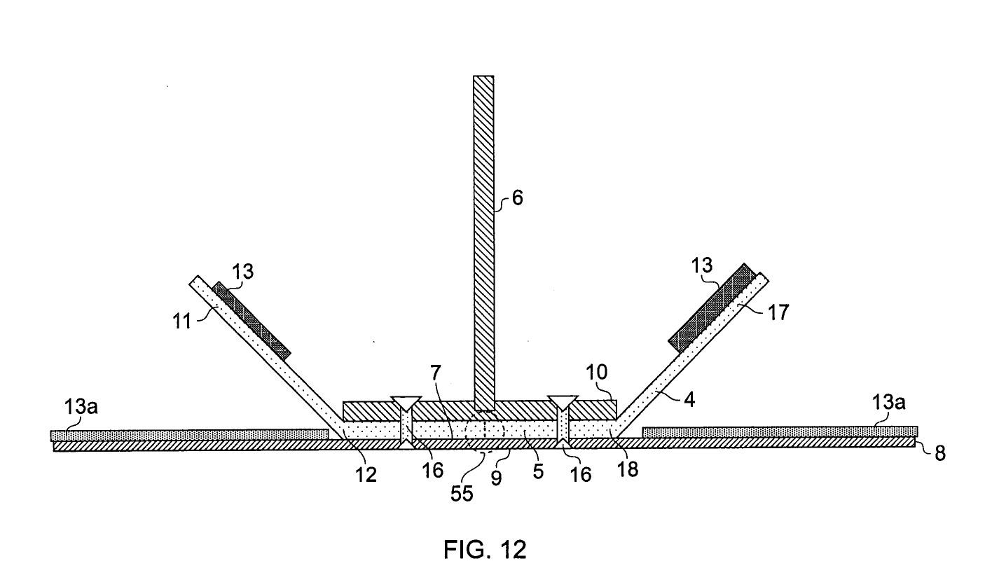

FIG. 12 shows a heat pipe configuration wherein the heat pipe 4 is a separate component from the support rib 6 and is arranged in a cavity, slot or recess between the support rib and the wing.

The heat pipe 4 is in effect sandwiched between the base portion 10 of the support rib 6 and the opposing internal surface 7 of the leading edge 8. In this example rivets 16 are used to secure the components in place.

A heat pipe corresponding generally to that shown in FIG. 4 is located in the recess and includes an evaporation portion 11 (a second portion of the pipe) extending from a condensing portion 5 (a first portion of the pipe). A heater mat 13 is affixed to the second portion 11 to provide heat energy to the first portion 5 and therefrom to the external surface 9 of the leading edge 8.

FIG. 12 also illustrates and optional third portion 17 extending from the opposite end 18 of the first portion 5. The third portion corresponds to a second evaporation portion of the heat pipe. A heater mat 13 is also affixed to the third portion 17 to provide heat energy to the first portion 5 through to the external surface 9 of the leading edge 8. The third portion 17 provides an additional surface area for a heater mat to be applied should greater heat energy be required at the wing surface. This may additionally provide some redundancy in the heating system should the first of the pair of heat pipes fail.

The dashed line 55 illustrates the optional feature of dividing the heat pipe into two separate heat pipes arranged to abut one another. The heat pipes in this arrangement may operate simultaneously or may be arranged to provide a backup or redundancy system should the primary heat pipe fail.

FIG. 12 also illustrates the positioning of additional heater mats 13a positioned on either side of the support rib 6. In a wing structure having multiple support ribs 6, heater mats 13a may be placed in the spaces between the support ribs 6 to provide heat energy to the entire length of the leading edge profile 8.

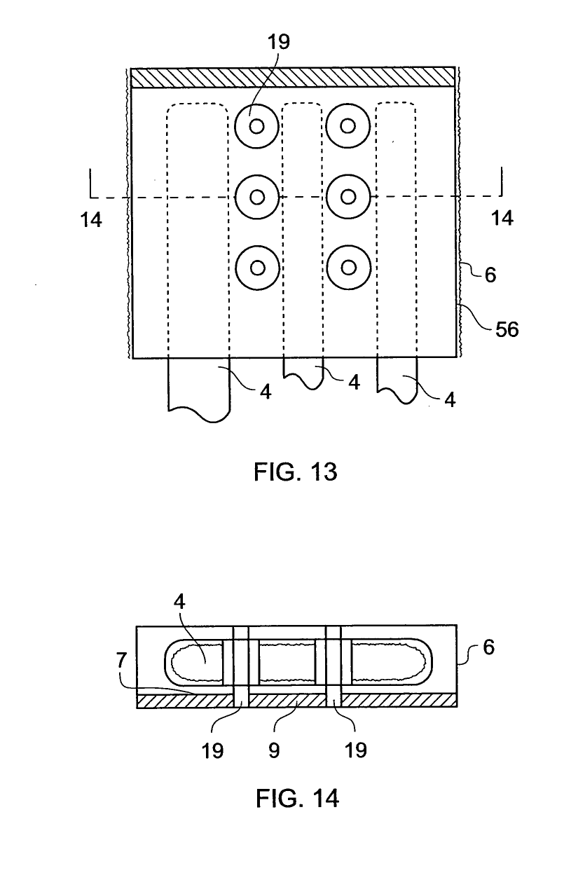

FIG. 13 shows a view of the coupling between the support rib and the leading edge. This corresponds generally to the region X shown in FIG. 6A. Holes 19 are shown through which rivets can be passed to couple the leading edge to the support rib. Three heat pipes 4 are shown extended from a cavity (denoted by the dashed line) within the support rib.

FIG. 14 shows a cross-section through 14-14′ in FIG. 13. The heat pipe 4 is divided into three channels to accommodate the through holes 19.

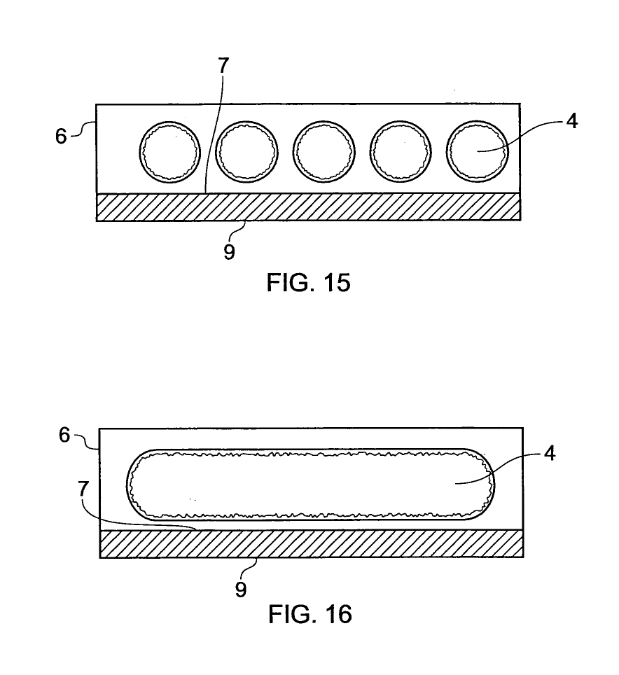

FIGS. 15 and 16 show alternative cross-sections of the support rib which correspond to that shown in FIG. 14. In FIG. 15 the cross-section of the base portion of a support rib 6 is adapted to integrally incorporate at least a portion of a heat pipe 4 in the form of cylindrical channels into which heat pipes may be arranged. Thus the cavity can be created by drilling holes into the support rib. Alternatively, in FIG. 16, the support rib includes a singular heat pipe 4 which is substantially rectangular in cross-section. This may be formed by milling the support rib for example.

Those skilled in the art will appreciate that the shape of the end of the support rib will be dependent on the structural requirements of the wing. Therefore, although the support rib 6 in the accompanying drawings is depicted as T-shaped in cross-section, the heating system of the present invention may be adapted to conform to any shaped support rib which has an end that abuts the internal surface of a leading edge profile to be heated.

Furthermore, in embodiments having a portion of the heat pipes integral with the support rib, or wholly encased within the support rib, the ends of the support ribs may be manufactured to allow space for those portions of the heat pipe to be inserted or assembled. For example, the support rib of the embodiment shown in FIGS. 10 and 11 could be cast, extruded or machined to provide the required cavity within the end of the support rib.

The amount of energy required to prevent ice formation varies in the vicinity of the wing leading edge. The highest impingement areas typically require 25 watts per square inch (6.4516×10⁻⁴ m²) compared to the areas towards the trailing edge of the wing that will typically require around 7 to 10 watts per square inch (6.4516×10⁻⁴ m²). The heat pipes may therefore be configured to output these required heat outputs through the support rib structure.

In use, either before or during flight, current is provided to the heater mats which in turn provide heat to their respective heat pipes. The heat is conveyed from the heated end of the heat pipe to the portion of the heat pipe proximate the area of the leading edge to be heated. The dissipated heat maintains the surface temperature of the leading edge area above freezing point to prevent ice formation.

To minimise the electrical load on the electrical systems of the aircraft the heat pipes may be sequentially operated to heat the wing. A suitable control arrangement may be provided to operate the individual heat pipes in the most efficient and economical sequence to prevent ice building up on the wing. Such a control arrangement may be arranged to control both the heat pipes and also the heat mats or heating systems arranged between adjacent support ribs.

Once the aircraft has landed, or is in an environment where ice will not form, current to the heater mats is terminated and the heat pipes stop supplying heat to the leading edge.

The illustrated heating system is advantageously able to provide heat energy quickly to a leading edge profile to allow a uniform level of heat energy to be dispersed across the length of the leading edge profile, improving the aerodynamic efficiency of an aircraft operating in below freezing conditions. The illustrated heating system also provides relatively easy access to heater mats should they require repair or replacement.

Although the invention has been described with reference to the above specific examples, it will be appreciated by those skilled in the art that the invention can be embodied in many other forms. Furthermore, although specific embodiments of the invention and combinations of features are described herein, it will be recognised that aspects of the invention extend to any suitable combination of the features described.

1. A heating system for a leading edge of an aircraft wing, said system comprising at least one heat pipe having a first end arranged in use to receive input heat and a second end arranged in use to dissipate heat, wherein said second end of said heat pipe is positioned between an end portion of a wing support rib and an adjacent portion of a wing leading edge.

2. A heating system according to claim 1, further comprising heating means adapted to provide said input heat to said first end of said heat pipe.

3. A heating system according to claim 1, wherein the first end of said heat pipe extends from said second end away from said support rib.

4. A heating system according to claim 2, wherein the heating means is an electrically operated heater and is coupled to said first end of said heat pipe.

5. A heating system according to claim 1, wherein the heat pipe is substantially rectangular in cross-section.

6. A heating system according to claim 1, wherein the heat pipe is substantially circular in cross-section.

7. A heating system according to claim 6, wherein the second end of said heat pipe is arranged to be received in a channel or cavity formed in a portion of said rib proximate to said leading edge.

8. A heating system as claimed in claim 1, wherein at least a part of said heat pipe is provided with curvature corresponding to the curvature of the inner surface of the wing leading edge.

9. A heating system as claimed in claim 1, comprising a plurality of heat pipes extending around at least a portion of an inner surface of a wing leading edge.

10. A heating system according to claim 1, wherein the rib is coupled to the leading edge surface through a plurality of holes extending through a portion of said rib proximate to the leading edge of said wing.

11. A heating system as claimed in claim 10, wherein the heat pipe is/are formed as conduits extending along and between a portion of the interface between the rib and the inner surface of the leading edge and wherein the holes are arranged between adjacent heat pipe conduits.

12. A heating system as claimed in claim 1, wherein the first end of said heat pipe is disposed at an angle relative to the elongate axis defined by the first end of said pipe extending from the rib/leading edge interface.

13. A method of heating a leading edge on an aircraft wing, the steps comprising: positioning at least a portion of a heat pipe between an end of an aircraft wing support rib and a portion of said leading edge proximate to said end of said support rib; and heating said heat pipe such that heat is transferred through said portion of said leading edge.

14. A support rib for an aircraft wing comprising a central beam portion and a circumferentially extending portion arranged to be coupled to an inner surface of a wing leading edge, said rib comprising at least one integral heat pipe arrangement having a first end arranged in use to receive input heat and a second end arranged in use to dissipate heat.

15. A support rib as claimed in claim 14, wherein said first end of said heat pipe is arranged in said central beam portion and said second end is arranged in said circumferentially extending portion.

16. A support rib as claimed in claim 14, comprising a plurality of radially extending heat pipes arranged in use to transfer heat from said first ends to said second ends proximate a wing leading edge.

17. An aircraft wing comprising a support rib according to claim 14.

18. An aircraft heating system comprising a heat pipe and an electrically operated heating mat, said heat pipe being arranged in use to be coupled at a first end to said electrically operated heating mat and at a second end to a portion of an aircraft structure.

19. A method of heating an aircraft component by activating a heating system according to claim 18.

20. (canceled)

21. (canceled)
